(19) United States
(12) Patent Application Publication
(10) Pub. No.: US 2015/0004356 A1
(43) Pub. Date: Jan. 1, 2015

(54) BOARD STRUCTURE

(71) Applicant: Robert LIN, Taipei City (TW)

(72) Inventor: Robert LIN, Taipei City (TW)

(21) Appl. No.: 13/931,723

(22) Filed: Jun. 28, 2013

(51) Int. Cl. B32B 3/04; B32B 21/02; B32B 21/04; B32B 3/08

(52) U.S. Cl. CPC B32B 3/04; B32B 3/08; B32B 21/02; B32B 21/045; B32B 2479/00
USPC 428/119

(57) ABSTRACT

A board structure is disclosed in the present invention. First, a chip board is cut into a predetermined size to be sent into an edge sealing machine. In the meantime, sealing materials are laminated onto the two corresponding side surfaces of the chip board, and chamfers are formed at the adjacent edges of the chip board. A flexible surface material is then laminated continuously along the two main surfaces of the chip board and the sealing material on one side of the chip board, so the three sequential adjacent edges of the board becomes seamless. In this way, the aesthetic appearance of the board is enhanced, the moist is prevented from entering into the chip board and the production cost of the shelves manufactured with board materials is reduced.

### BACKGROUND OF THE INVENTION

1. Field of the Invention

The present invention relates to a board structure, especially relates to a board structure for use in a seamless panel furniture, such as cabinets and cupboards.

2. The Prior Arts

The body of the panel furniture is composed of multiple panels. Based on the expected properties and the appearance, a layer of surface material is usually laminated on the chip board of the panel. The chip board can be a particle board, a block board, plywood or a medium density fiber board (MDF). The surface material can be PVC, foil paper, melamine paper and etc.

As shown in FIG. 1, the panels used in the body of the panel furniture are conventionally manufactured by sandwiching the chipboard A with prepared surface material B, such as the melamine face chipboard, MFC, or the melamine face, MDF. Next, as shown in FIG. 2, the chip board is cut into a desired width with a board cutting machine, and the side surfaces of the chip board are sealed with sealing materials C by the edge sealing machine. However, in this way, seams D exist between the surface material B on the two sides of the panel and the sealing material C, as shown in FIG. 2B. When assembling the body of the cupboard or cabinet with this kind of panels, the seams are exposed to the atmosphere, thereby letting the moist enter and causing the panel to expand, or having residual fouling after wiping. In addition, after a period time of use, the sealing material may slip off easily due to the entering of the moist into the panels.

### SUMMARY OF THE INVENTION

The primary purpose of the present invention is to provide a panel for assembling the body of cupboards and cabinets. The exposed part of the panel has a seamless structure at the adjacent edge of the surfaces, so that the aesthetic appearance of the cupboards and cabinets is improved, and the moist is prevented from entering into the board structure. In this way, the problem of the falling sealing material in the conventional board structure can be solved.

In the present invention, the chip board is cut into a desired width, and the two side surfaces of the chip board are sealed with sealing materials. The adjacent edge between the side surfaces and main surfaces are chamfered precisely before a surface material is laminated onto the main surface of the chip board. The surface material is wrapped along the sealing material on one side of the chip board, and extends to another main surface on another opposite side to form a board structure. After certain modification, the two main surfaces, one side surface of the board and the surfaces of the adjacent edges therebetween becomes an integral piece without any seams. When assembling the cupboard body with the boards according to the present invention, the seamless part of the board is assembled facing outward, so the seamless part of the board is facing the side where contact with moist is more likely to happen. Due to the seamless feature of the board structure, the edges of the cupboard panels do not fall off anymore, and the panels do not expand anymore due to the moist.

According to the present invention, first, the chip board is cut into a predetermined size to be sent into an edge sealing machine. In the meantime, sealing materials are laminated onto the two corresponding side surfaces of the chip board, and chamfers are formed at the adjacent edges of the chip board. The flexible surface material is then laminated continuously along the two main surfaces of the chip board and the sealing material on one side of the chip board, so the three sequential adjacent edges of the board becomes seamless. In this way, the aesthetic appearance of the board is enhanced, the moist is prevented from entering into the chip board and the production cost of the shelves manufacturing with board materials is reduced.

The board structure provided by the present invention includes a rectangular chip board, two sealing materials and a surface material. The chip board has first and second main surfaces that are parallel to each other, first and second side surfaces that area parallel to each other, and a third and fourth side surfaces that are parallel to each other. The two sealing materials are laminated on the first side surface and the second side surface, and the adjacent edges between the first and the second main surfaces and the two sealing materials are chamfered. The flexible surface material with suitable thickness is laminated continuously along the first main surface, second main surface and one side of the sealing material.

The adjacent edge between the first main surface and one side of the sealing material is chamfered, and so is the adjacent edge between the second main surface and the other side of the sealing material. In this way, the surface material has a finished smooth surface when wrapped around the first main surface, one side of the sealing material and the second main surface.

Preferable, the chamfers on the chip board are formed with round corners.

With the structure described above, the board structure according to the present invention avoids exposing seams in the atmosphere by eliminating the seams at the adjacent edges between adjoining surfaces, so the panel is more integrated and the aesthetic appearance of the panel is also improved. In addition, the moist is prevented from entering into and hence damaging the panel and the processing procedure is simplified, thereby lowering the production cost of the panel.

The panel furniture assembled with the panels having board structures as described above have the following advantages:

a. aesthetically pleasing appearance and high durability: due to the elimination of the exposed sealing material and the seams at the adjacent edge thereof, the board structure has a more integrated and aesthetic appearance; in addition, the moist is also prevented from entering the board structure, thereby preventing the board from expanding.

b. high durability: without the sealing material exposed in the atmosphere, the difference between the color of the board material and the PVC sealing material can be eliminated, and the problem of the falling and color-fading of the PVC sealing material can also be resolved as well.

c. energy saving: boiler is no longer needed in the process of production, therefore, the production line can be set up in both first tier and second tier cities, saving a great amount of energy.

d. easy to store: the board structure according to the present invention does not need to be store in the air-conditioned rooms with constant temperature and humidity, like the MFC or MDF boards do.

e. zero formaldehyde release: because the board structure according to the present invention does not need to be soaked in the glue, it does not contain any formaldehyde which can be harmful to human bodies.

f. higher degree of anti-wear: in the wear test of the same conditions, the board structure of the present invention can stand up to 1000 turns, whereas the conventional MFC or MDF boards can only stand up to 350 turns.

g. authenticity of the pattern: because the glue soaking process is eliminated, the printing on the surface material can stay from being damaged, therefore the authenticity of the pattern is high as if they were real wood patterns.

h. high processability: the surface material in the present invention is laminated continuously onto the surface of the chip board, and the speed of the lamination can be as high as 25 meters per minute, which is way better than the conventional short-cycle pressing machine.

i. factory property of the board structure: PUR glue is used to laminate the board structure of the present invention. Unlike the conventional short-cycle pressing machine, the polymerization of the glue in the board structure of the present invention is not damaged.

### BRIEF DESCRIPTION OF THE DRAWINGS

FIG. 1 is a perspective and exploded view showing the conventional board structure which sandwiches the chip board with two surface materials from above and below;

FIG. 2A is a perspective view showing the lamination of the two sealing materials on the two opposite side surfaces of the chip board in the conventional board structure;

FIG. 2B is a perspective view showing the conventional board structure after the sealing materials are laminated on the two opposite side surfaces;

FIG. 3A is a plane view showing the chip board, which is cut into a predetermined width according to an embodiment of the present invention;

FIG. 3B is a plane view showing the chip board in FIG. 3A with two sealing materials laminated onto the side surfaces thereof according to an embodiment of the present invention;

FIG. 3C is a plane view showing the chip board in FIG. 3B being further wrapped by a surface material according to an embodiment of the present invention; and

FIG. 3D is a plane view showing the board structure of the present invention with the surface material wrapped around the board.

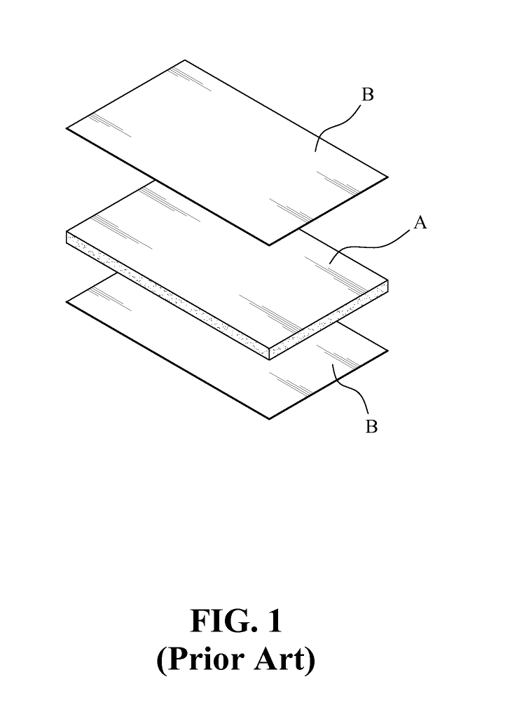

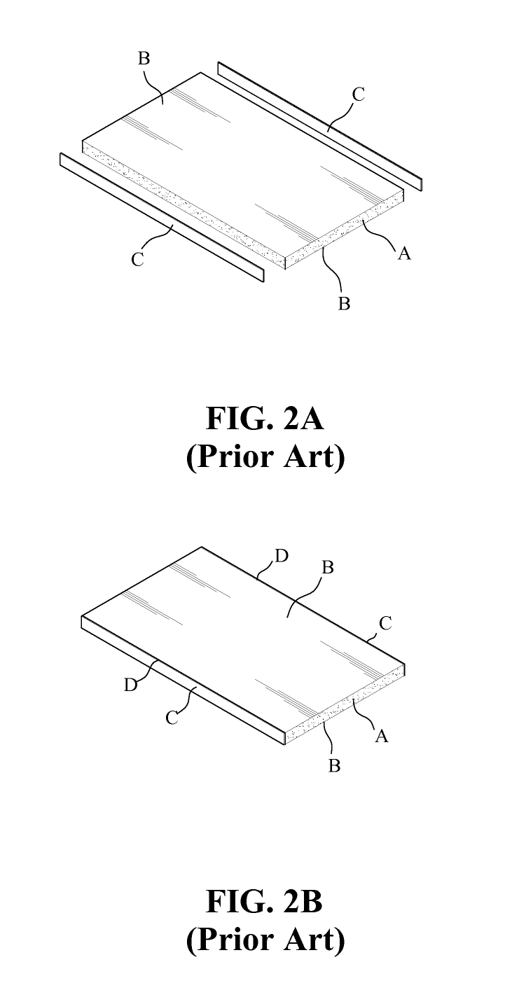

### DETAILED DESCRIPTION OF THE PREFERRED EMBODIMENT

The present invention will be apparent to those skilled in the art by reading the following detailed description of preferred embodiments thereof, with reference to the attached drawings.

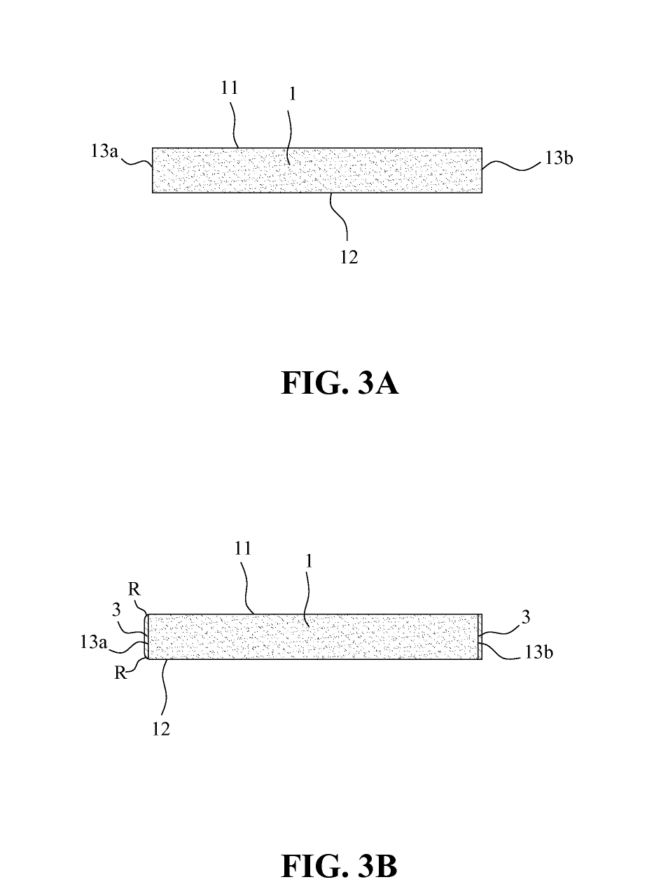

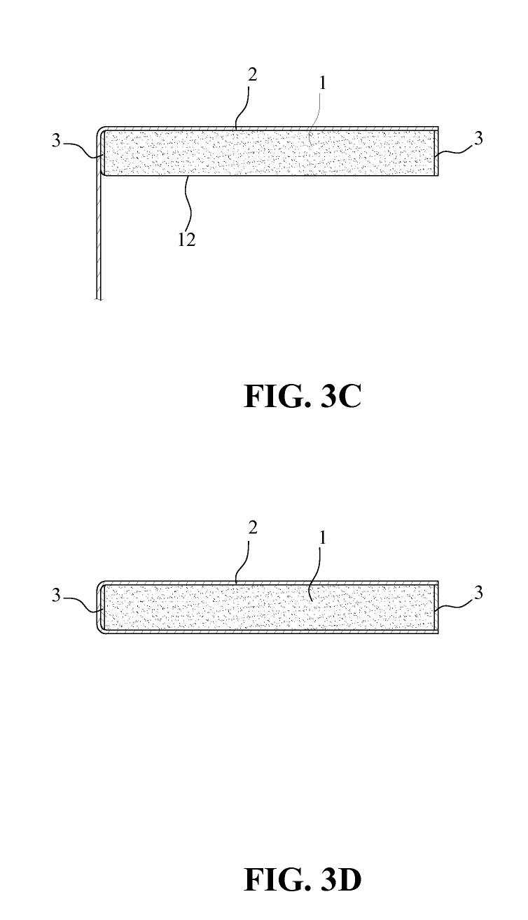

FIG. 3A to FIG. 3D are the plane views showing the board structure according to the preferred embodiment of the present invention. The board structure according to the preferred embodiment includes a chip board 1. The chip board 1 can be a thinner material, such as a particle board, a block board, plywood, a medium density fiber board (MDF), or boards that are formed with compressed fibers of edge materials. The chip board 1 is formed with a first main surface 11 and a second main surface 12 that are located on the top and bottom of the chip board 1 respectively. The chip board 1 is also formed with a first side surface 13a and a second side surface 13b on the two opposite ends, and with a third side surface and a fourth side surface (not shown) on the other two opposite ends of the chip board 1. In the preferred embodiment, the first side surface 13a is parallel to the second side surface 13b, and the third side surface is parallel to the fourth side surface. The chip aboard 1 is cut into a desired width according to the panel size needed for assembling the cupboard, as shown in FIG. 3A. Next, the chip board 1 is sent through a specifically made “double edge sealing machine”, so that the first side surface 13a and the second side surface 13b are sealed with a sealing material 3. In the meantime, the double edge sealing machine also chamfers the adjacent edge between the first main surface 11 and one side of the sealing material 3, and the adjacent edge between the second main surface 12 and the other side of the sealing material 3. The chamfers R are formed with round corners, as shown in FIG. 3B. Then, the board is sent through a specifically made wrapping machine for the wrapping of the surface material 2. The flexible surface material 2 is first laminated onto the first main surface 11 in such way that one side of the surface material 2 is aligned with the sealing material 3 so as to seal the seam at the adjacent edge. The surface material 2 is then bent to wrap the sealing material 3 on the other side of the chip board 1, as shown in FIG. 3C, and is further wrapped around the board to as to be laminated on the second main surface 12, as shown in FIG. 3D. Finally, the end of the surface material 2 is made sure to be aligned with the sealing material 3 to seal the seam at the adjacent edge.

The abovementioned surface material 2 is a material with the characteristics of wear-resistant, moist-resistant, water-proof and aesthetically pleasing, such as PVC, ABS and melamine paper. The surface material 2 has a relatively small thickness comparing to the chip board 1. The surface material 2 is flexible, so that the same can be rolled into the shape of a roller to be installed in the profession laminating machine for laminating onto the chip board 1, and also can be installed in the wrapping machine for wrapping the chip board 1.

The preferred embodiment described above is disclosed for illustrative purpose but to limit the modifications and variations of the present invention. Thus, any modifications and variations made without departing from the spirit and scope of the invention should still be covered by the scope of this invention as disclosed in the accompanying claims.

What is claimed is:

1. A board structure, comprising:
a rectangular chip board having a first main surface and a second main surface parallel to each other, a first side surface and a second side surface parallel to each other, and a third side surface and a fourth side surface parallel to each other;
two sealing materials laminated on said first side surface and said second side surface respectively; and
a flexible surface material laminated continuously along said first main surface of said chip board, one side of said sealing material and said second main surface.

2. The board structure as claimed in claim 1, wherein a chamfer is formed at an adjacent edge between said first main surface of said chip board and one of said sealing material, and another chamfer is formed at the adjacent edge between said second main surface and said sealing material on the side thereof.

3. The board structure as claimed in claim 2, wherein said chamfers are formed with round corners.
